(19) United States
(12) Patent Application Publication
(10) Pub. No.: US 2023/0307871 A1
(43) Pub. Date: Sep. 28, 2023

(54) LEVER-TYPE CONNECTOR

(71) Applicant: JAPAN AVIATION ELECTRONICS INDUSTRY, LIMITED, Tokyo (JP)

(72) Inventor: Yuya OKUYAMA, Tokyo (JP)

(73) Assignee: JAPAN AVIATION ELECTRONICS INDUSTRY, LIMITED, Tokyo (JP)

(21) Appl. No.: 18/020,836

(22) PCT Filed: Jun. 11, 2021
(86) PCT No.: PCT/JP2021/022302

§ 371 Date: Feb. 10, 2023

(30) Foreign Application Priority Data
Sep. 16, 2020 (JP) 2020-155553

(51) Int. Cl. H01R 13/629

(52) U.S. Cl. CPC H01R 13/62977

(57) ABSTRACT

In a connector that includes a slider having a cam groove which a boss of a mating connector is to enter and a lever making the slider perform an operation, sliders are positioned in a space between an inner housing and an outer housing, and a protrusion is formed on one of the sliders and the inner housing and a concave portion is formed on the other. In a separation state from the mating connector, the sliders are pushed by spring pieces to be in a locked state, in which the protrusion enters the concave portion, and accordingly, the sliding operation and the operation of a lever are both blocked. When fitting with the mating connector is started, the sliders are pushed by the mating connector, and accordingly, the sliders are displaced in directions separating from the inner housing, and the locked state is released.

### TECHNICAL FIELD

The present invention relates to a lever-type connector that can reduce an operating force in fitting with and separation from a mating connector.

### BACKGROUND ART

FIGS. 1(a) and 1(b) illustrate a lever-type connector 10 described in Patent Literature 1 as a conventional example of a lever-type connector. FIG. 1(a) illustrates a state in which a lever 11 is on a separation position and FIG. 1(b) illustrates a state in which the lever 11 is on a fitted position.

In FIGS. 1(a) and 1(b), 12 denotes an outer housing and 13 denotes a front cover. Further, 14 denotes a slider and 15 denotes a wire cover. An inner housing, holding a contact, and the like (hidden and not seen) are accommodated in the outer housing 12 and the front cover 13 is attached to a front end of the inner housing.

The lever 11 is attached to the outer housing 12 so as to rotate in both of an arrow a direction illustrated in FIG. 1(a) and an arrow b direction illustrated in FIG. 1(b) with respect to the outer housing 12.

FIG. 1(c) illustrates a state in the middle of fitting of the lever-type connector 10 with respect to a counterpart connector 20. A protrusion for slider movement 11a provided on the lever 11 is inserted and fitted to a concave portion 14d of the slider 14. The protrusion for slider movement 11a pushes the slider 14 in an arrow c direction in response to rotation of the lever 11 and the slider 14 slides in a slider accommodating groove 12a, which is provided to the outer housing 12, in conjunction with the lever 11.

Cam grooves 14a to 14c are formed in the slider 14, as illustrated in FIG. 1(c). Into the cam grooves 14a to 14c, cam pins 21a to 21c provided to a fitting portion 21 of the counterpart connector 20 are respectively inserted. When the slider 14 is slid by rotating the lever 11 from the separation position illustrated in FIG. 1(a) to the fitted position illustrated in FIG. 1(b), the lever-type connector 10 and the counterpart connector 20 are mutually drawn by the action between the cam grooves 14a to 14c and the cam pins 21a to 21c, completing the fitting.

A restricting protrusion 15a and a locking member 15b are provided to the wire cover 15 that is attached to a rear end of the outer housing 12. The restricting protrusion 15a restricts the rotation in the arrow a direction of the lever 11 from the separation position and the locking member 15b prevents the rotation in the arrow b direction of the lever 11 from the fitted position.

### PRIOR ART LITERATURE

### Patent Literature

Patent Literature 1: Japanese Patent Application Laid Open No. 2010-199025

### SUMMARY OF THE INVENTION

### Problems to be Solved by the Invention

In the lever-type connector 10 described above, the lever 11 rotates if a greater force than the restricting force of the restricting protrusion 15a is applied to the lever 11. Therefore, if such a force is applied to the lever 11 even in other than the fitting with the counterpart connector 20, the lever 11 may rotate and the slider 14 may slide in conjunction with the lever 11.

Such sliding of the slider 14 causes deviation of the positions of the cam grooves 14a to 14c with respect to the cam pins 21a to 21c of the counterpart connector 20, making the fitting with the counterpart connector 20 impossible. This brings the necessity to check whether the lever 11 is on the separation position illustrated in FIG. 1(a), that is, on a position on which rotation is restricted by the restricting protrusion 15a, in the fitting with the counterpart connector 20. A case where the position is deviated requires an operation to raise the lever 11 and position the lever 11 on the position illustrated in FIG. 1(a). Thus, the lever-type connector 10 of the related art illustrated in FIG. 1 requires such an operation, exhibiting poor usability.

In view of this situation, an object of the present invention is to provide a lever-type connector whose lever does not move even when a force is applied to the lever other than in fitting with a mating connector.

### Means to Solve the Problems

The technical matters described herein are not intended to expressly or implicitly limit the invention described in the claims, or, moreover, are not a statement of the possibility of accepting such limitation by persons other than those who benefit from the present invention (for example, the applicant and the right holder), but are merely described to facilitate an understanding of the gist of the present invention. An overview of the present invention from another point of view can be understood, for example, from the scope of claims at the time of filing this patent application.

In a separation state between the lever-type connector and a mating connector, a slider is locked by a spring mechanism. Accordingly, a lever coupled to the slider does not move in the separation state. The locking by the spring mechanism is released at the start of fitting between the lever-type connector and the mating connector. A user can operate the lever coupled to the slider, in a non-separation state.

### Effects of the Invention

According to the present invention, the lever does not move from a predetermined position even when a force is applied to the lever in the separation state from the mating connector. Therefore, the present invention eliminates the necessity of the conventionally-required operation, which is checking whether a lever is on a predetermined position in fitting with a mating connector, and favorable usability is thus achieved.

### BRIEF DESCRIPTION OF THE DRAWINGS

FIG. 1 is a drawing illustrating a conventional lever-type connector. FIG. 1(a) is a plan view in a state in which a lever is on a separation position. FIG. 1(b) is a plan view in a state in which the lever is on a fitted position after rotating from the position illustrated in FIG. 1(a). FIG. 1(c) is a drawing for explaining a state in the middle of fitting between the lever-type connector illustrated in FIG. 1(a) and a counterpart connector.

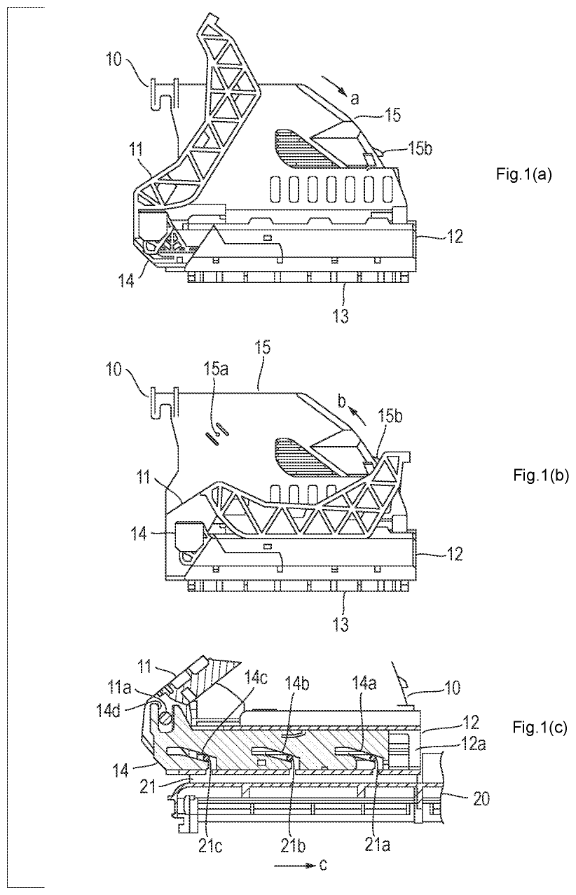

FIG. 2 is a perspective view illustrating a lever-type connector according to a first embodiment of the present invention.

FIG. 3 is an exploded perspective view of the lever-type connector illustrated in FIG. 2.

FIG. 4 is a drawing illustrating one slider. FIG. 4(a) is an enlarged perspective view of one slider of FIG. 3 viewed from above. FIG. 4(b) is an enlarged perspective view of one slider of FIG. 3 viewed from below.

FIG. 5 is a drawing illustrating an inner housing. FIG. 5(a) is an enlarged perspective view of the inner housing of FIG. 3 viewed from above. FIG. 5(b) is an enlarged perspective view of the inner housing of FIG. 3 viewed from below.

FIG. 6 is a drawing for explaining processes of fitting between the lever-type connector illustrated in FIG. 2 and a mating connector. FIG. 6(1)(a) is a plan view of a fitting state between the lever-type connector and the mating connector in a process (1). FIG. 6(2)(a) is a plan view of a fitting state between the lever-type connector and the mating connector in a process (2). FIG. 6(1)(b) illustrates an enlarged longitudinal section of a main portion in the fitting state between the lever-type connector and the mating connector in the process (1). FIG. 6(2)(b) illustrates an enlarged longitudinal section of a main portion in the fitting state between the lever-type connector and the mating connector in the process (2).

FIG. 7 is a drawing for explaining processes of fitting between the lever-type connector illustrated in FIG. 2 and the mating connector. FIG. 7(3)(a) is a plan view of a fitting state between the lever-type connector and the mating connector in a process (3). FIG. 7(4)(a) is a plan view of a fitting state between the lever-type connector and the mating connector in a process (4). FIG. 7(3)(b) illustrates an enlarged longitudinal section of a main portion in the fitting state between the lever-type connector and the mating connector in the process (3). FIG. 7(4)(b) illustrates an enlarged longitudinal section of a main portion in the fitting state between the lever-type connector and the mating connector in the process (4).

FIG. 8 is a drawing for explaining processes of fitting between the lever-type connector illustrated in FIG. 2 and the mating connector. FIG. 8(a) is a sectional view taken along an E-E line shown in FIG. 6(1)(b). FIG. 8(b) is a sectional view taken along an F-F line shown in FIG. 6(2)(b).

FIG. 9 illustrates transverse sections on a position where a rack of the slider is positioned in the fitting state between the lever-type connector illustrated in FIG. 2 and the mating connector. FIG. 9(a) is a transverse section in the process (2). FIG. 9(b) is a transverse section in the process (3). FIG. 9(c) is a transverse section in a state between the process (3) and the process (4). FIG. 9(d) is a transverse section in the process (4).

FIG. 10 is a perspective view illustrating a lever-type connector according to a second embodiment of the present invention.

FIG. 11 is an exploded perspective view of the lever-type connector illustrated in FIG. 10.

FIG. 12 is a drawing for explaining processes of fitting between the lever-type connector illustrated in FIG. 10 and a mating connector. FIG. 12(1)(a) is a plan view of a fitting state between the lever-type connector and the mating connector in a process (1). FIG. 12(2)(a) is a plan view of a fitting state between the lever-type connector and the mating connector in a process (2). FIG. 12(1)(b) illustrates an enlarged longitudinal section of a main portion in the fitting state between the lever-type connector and the mating connector in the process (1). FIG. 12(2)(b) illustrates an enlarged longitudinal section of a main portion in the fitting state between the lever-type connector and the mating connector in the process (2).

FIG. 13 is a drawing for explaining processes of fitting between the lever-type connector illustrated in FIG. 10 and the mating connector. FIG. 13(3)(a) is a plan view of a fitting state between the lever-type connector and the mating connector in a process (3). FIG. 13(4)(a) is a plan view of a fitting state between the lever-type connector and the mating connector in a process (4). FIG. 13(3)(b) illustrates an enlarged longitudinal section of a main portion in the fitting state between the lever-type connector and the mating connector in the process (3). FIG. 13(4)(b) illustrates an enlarged longitudinal section of a main portion in the fitting state between the lever-type connector and the mating connector in the process (4).

FIG. 14 is a drawing for explaining a lever-type connector according to a third embodiment of the present invention. FIG. 14(a) is a plan view illustrating states of a lever and a slider in a separation state between the lever-type connector and a mating connector. FIG. 14(b) is a side view of FIG. 14(a). FIG. 14(c) is a partial sectional view of FIG. 14(a).

FIG. 15 is a drawing for explaining the lever-type connector according to the third embodiment of the present invention. FIG. 15(a) is a plan view illustrating states of the lever and the slider when a locked state of the slider is released. FIG. 15(b) is a side view of FIG. 15(a). FIG. 15(c) is a partial sectional view of FIG. 15(a).

### DETAILED DESCRIPTION OF THE EMBODIMENTS

Embodiments of the present invention will be described based on examples with reference to the accompanying drawings.

### First Embodiment

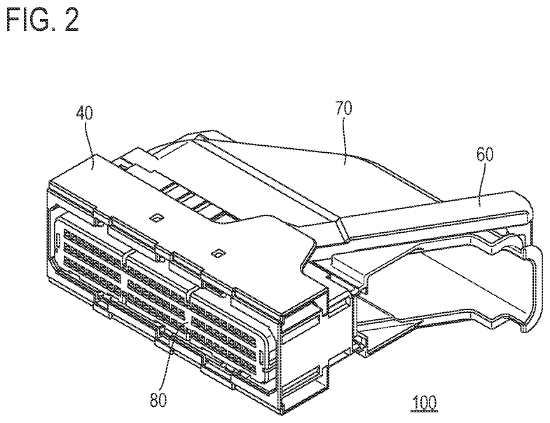

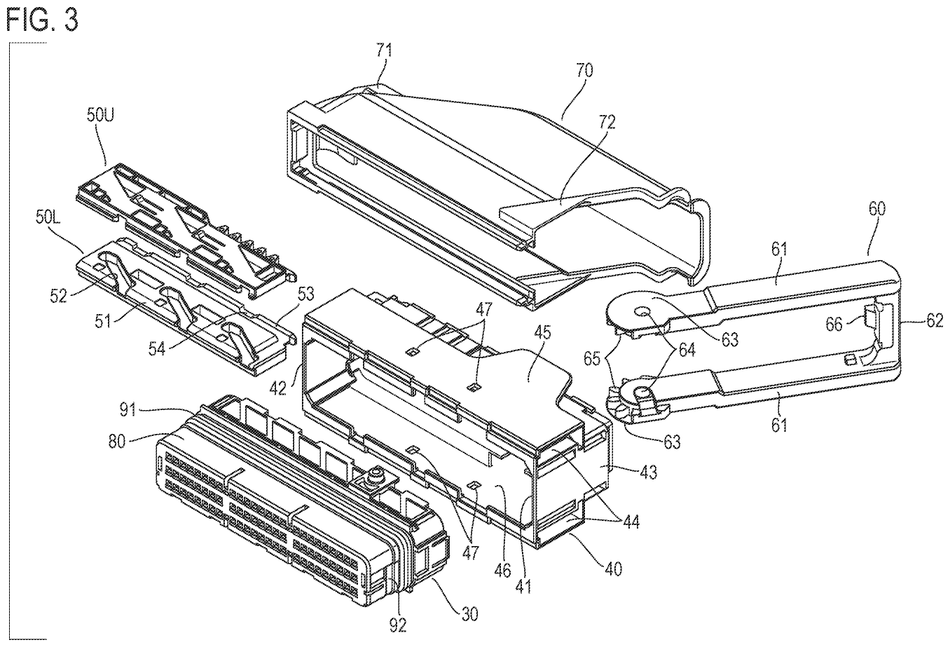

FIG. 2 illustrates an outer appearance of a lever-type connector according to a first embodiment of the present invention, and FIG. 3 illustrates the lever-type connector 100 shown in FIG. 2 as an exploded view with some portions removed.

The lever-type connector 100 in this example is composed of an inner housing 30, an outer housing 40, two sliders 50U and 50L, a lever 60, a harness cover 70, a seal stopper 80, a seal ring 91, a retainer 92, a grommet, and a large number (75 in this example) of socket contacts. Here, FIG. 3 illustrates the seal ring 91, the retainer 92, and the seal stopper 80 as these are attached to the inner housing 30 and FIG. 3 omits the illustration of the grommet and socket contacts.

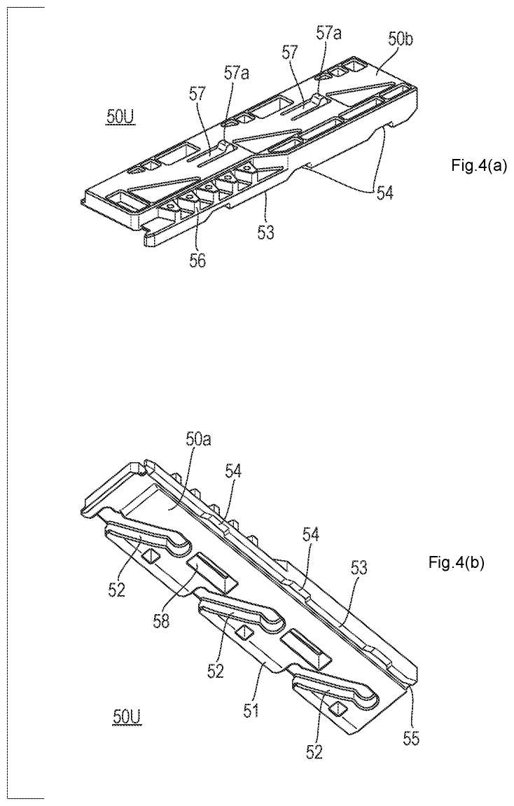

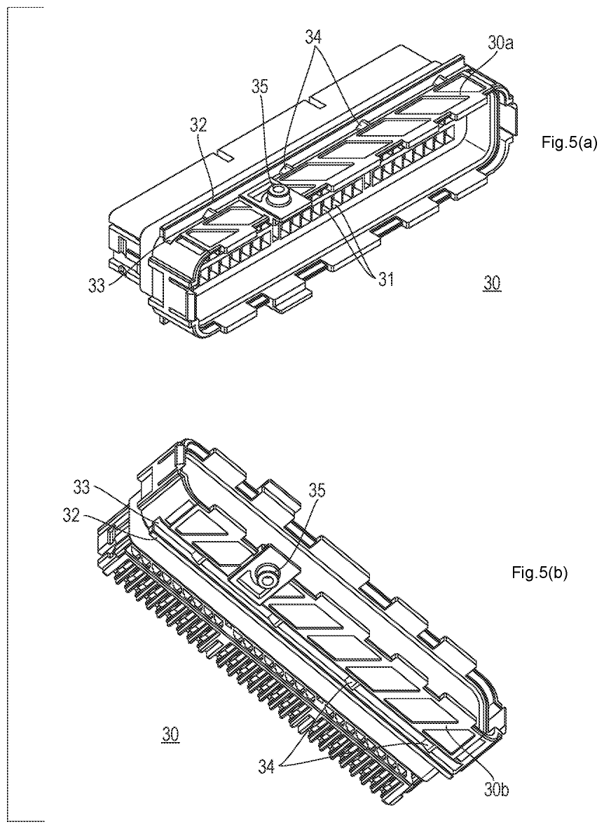

FIGS. 4 and 5 illustrate details of the slider 50U and the inner housing 30 respectively. The shape of the slider 50U will be first described.

The slider 50U has a substantially rectangular plate shape as illustrated in FIG. 4, and one long side of a lower surface 50a is chamfered to be an inclined surface 51 formed along the long side. On the lower surface 50a, three cam grooves 52 are further formed to be arrayed in a long side direction of the slider 50U. Each of the cam grooves 52 has an opening, which a driven boss of a later-described mating connector is to enter, on the long side on which the inclined surface 51 is formed.

A projecting portion 53 projecting from the lower surface 50a is formed along the other long side of the lower surface 50a, and concave portions 54 are formed in a notched manner respectively on three spots in an extending direction of the projecting portion 53. Further, a groove 55 extending along the projecting portion 53 is formed on an inner side of the projecting portion 53 on the lower surface 50a.

Meanwhile, on an upper surface 50b of the slider 50U, a rack 56 is formed on a side, which corresponds to the long side on which the projecting portion 53 is formed, in a manner to be positioned along a substantially half portion of the long side of the upper surface 50b. The teeth of the rack 56 are arrayed along the long side and the tips of the teeth are positioned on the long side. Here, the rack 56 is formed by digging the upper surface 50b.

Further, two spring pieces 57 are formed on the upper surface 50b. The spring piece 57 cantilevers along the upper surface 50b and a convex portion 57a protruding from the upper surface 50b is formed on an end of the spring piece 57. Here, two windows 58 are formed on the slider 50U in a manner to penetrate through the slider 50U in a thickness direction of the slider 50U. The two spring pieces 57 are integrally formed on the slider 50U so as to be positioned in these windows 58 respectively.

The shape of the slider 50U has been described above. The other slider 50L has a shape mirroring the shape of the slider 50U and accordingly, portions corresponding to those of the slider 50U are provided with the same reference characters and detailed description thereof will be omitted.

The inner housing 30 has a substantially rectangular parallelepiped outer shape as illustrated in FIG. 5, and a large number of insertion holes 31 are formed inside in an array in a manner to penetrate in a front-rear direction. In the insertion holes 31, the socket contacts are inserted and held. On an upper surface 30a of the inner housing 30, a projection portion 32 which is long and thin is formed in a projecting manner. The projection portion 32 extends from one end to the other end of the upper surface 30a in a left-right direction which is orthogonal to the penetrating direction (the front-rear direction) of the insertion hole 31. On a rear end side from the projection portion 32 on the upper surface 30a, a groove 33 is formed to extend along the projection portion 32. On a bottom surface of the groove 33, four protrusions 34 are formed in a manner to be arrayed in an extending direction of the groove 33. The protrusion 34 protrudes in a triangular shape. Here, a supporting shaft 35 is formed in a protruding manner on the rear end side from the groove 33 on the upper surface 30a. The supporting shaft 35 is used for attaching and supporting the lever 60.

The projection portion 32, the groove 33, the protrusions 34, and the supporting shaft 35, which are described above, are also similarly formed on a lower surface 30b of the inner housing 30 so as to correspond to respective positions on the upper surface 30a.

The outer housing 40 has a box shape having an accommodation space 41 as illustrated in FIG. 3. Openings 44 each communicating with the accommodation space 41 are formed on upper portions and lower portions of left and right side surfaces 42 and 43 of the outer housing 40. Further, two small windows 47 are provided on each of an upper plate portion 45 and a bottom plate portion 46 of the outer housing 40.

The lever 60 has a U shape formed by two arm portions 61 and a coupling portion 62 that couples the arm portions 61 to each other, as illustrated in FIG. 3. A disc portion 63 is formed on one end (tip) of each arm portion 61, and a shaft hole 64 is formed on the center of the disc portion 63. A gear 65 centering on the shaft hole 64 is formed on an inner surface of each of the disc portions 63, which are opposed to each other, of the two arm portions 61. A protrusion 66 is formed on the coupling portion 62 that couples the other ends of the two arm portions 61.

The configurations of the main portions have been described above. The lever-type connector 100 is assembled by accommodating the inner housing 30, to which the seal ring 91, the retainer 92, and the seal stopper 80 are attached as illustrated in FIG. 3, in the accommodation space 41 of the outer housing 40 and by attaching the harness cover 70, the lever 60, and the sliders 50U and 50L. Wires of a wire harness which is not illustrated are threaded through grommets and connected to socket contacts whose illustration is omitted. The socket contacts are respectively inserted in the insertion holes 31 of the inner housing 30 and are held by the inner housing 30 and the retainer 92.

The harness cover 70 is attached to the outer housing 40, and the lever 60 is attached to the inner housing 30 by threading a pair of supporting shafts 35 of the inner housing 30 through a pair of shaft holes 64 so that the lever 60 can rotate about the supporting shaft 35. The sliders 50U and 50L are inserted from the openings 44 on the side surface 42 side of the outer housing 40 and incorporated in the upper and lower spaces between the outer housing 40 and the inner housing 30, and the racks 56 of the sliders 50U and 50L are engaged with respective gears 65 of the lever 60.

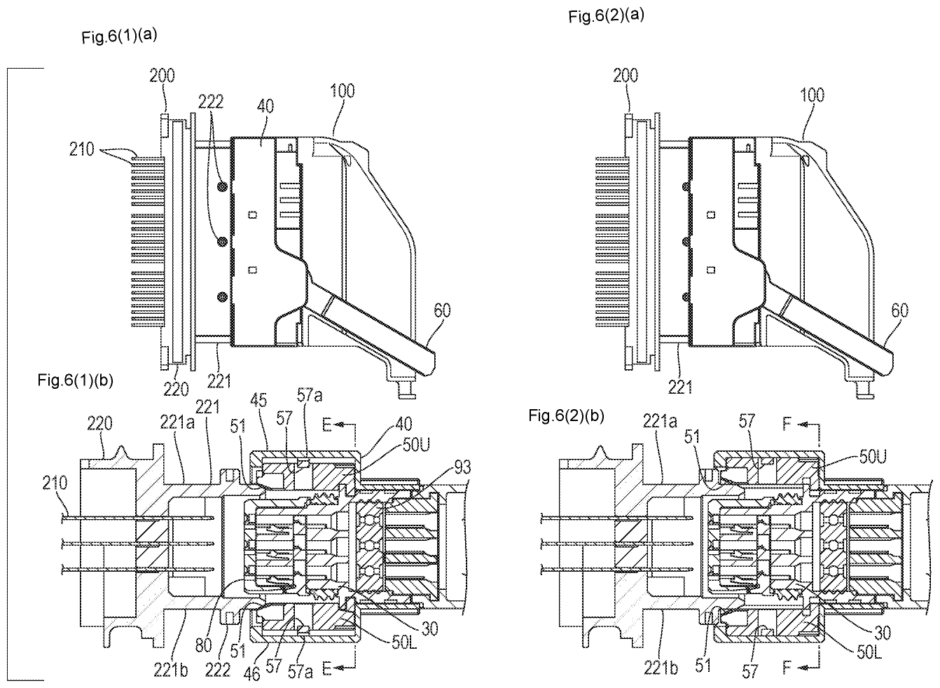

A fitting operation between the lever-type connector 100 described above and the mating connector will now be described with reference to FIGS. 6 to 9.

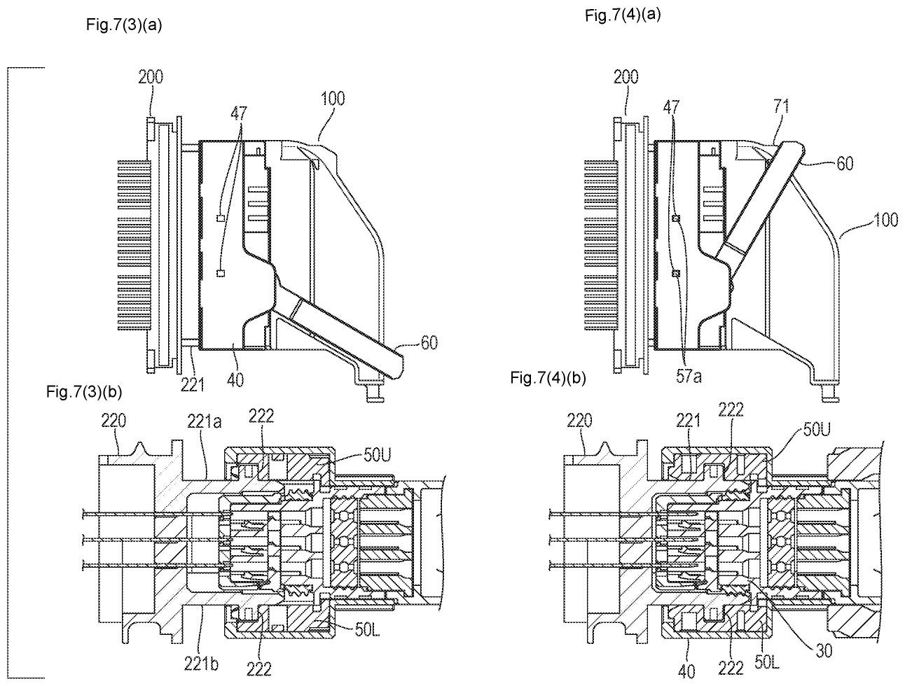

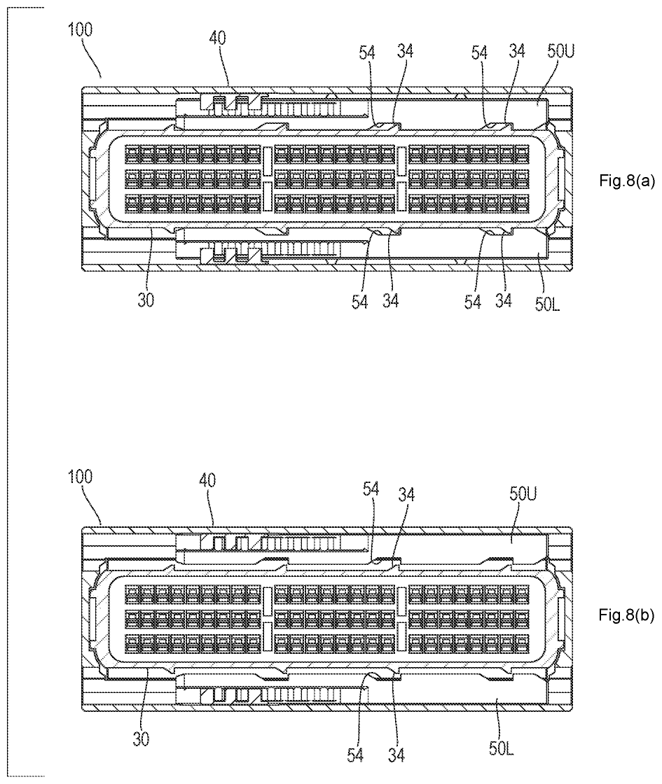

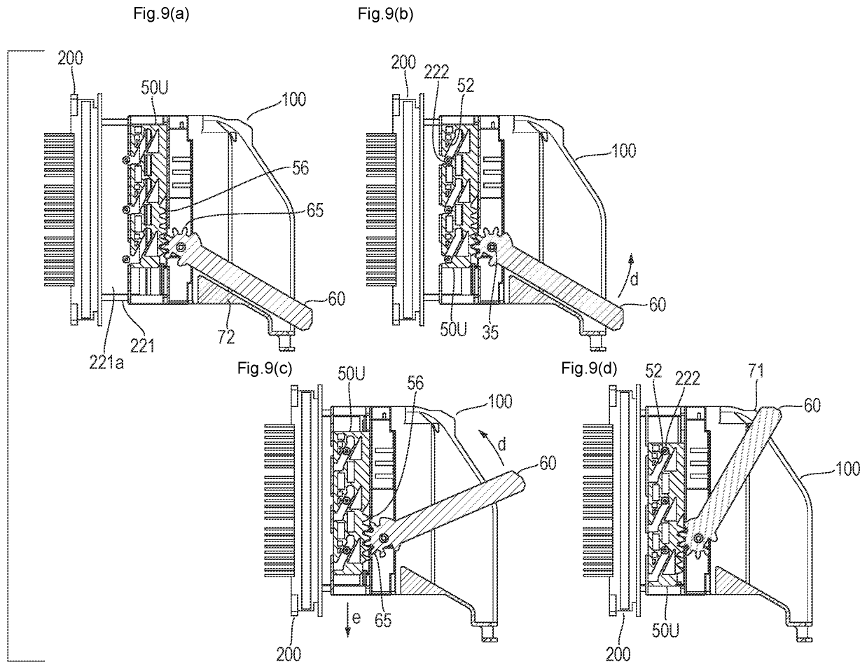

FIGS. 6(1) and 6(2) and FIGS. 7(3) and 7(4) illustrate processes (1) to (4) of fitting between the lever-type connector 100 and a mating connector 200 in order. FIGS. 6(1)(a) and 6(2)(a) and FIGS. 7(3)(a) and 7(4)(a) are plan views of the fitting state between the lever-type connector 100 and the mating connector 200. FIGS. 6(1)(b) and 6(2)(b) and FIGS. 7(3)(b) and 7(4)(b) illustrate an enlarged longitudinal section of a main portion of the fitting state. FIGS. 8(a) and 8(b) respectively illustrate a section taken along the E-E line shown in FIG. 6(1)(b) and a section taken along the F-F line shown in FIG. 6(2)(b). FIG. 9 illustrates transverse sections on a position where the rack 56 of the slider 50U is positioned in the fitting state between the lever-type connector 100 and the mating connector 200. FIGS. 9(a), 9(b), and 9(d) correspond to the processes (2), (3), and (4) respectively and FIG. 9(c) corresponds to the state between the processes (3) and (4).

Process (1): Initial Stage in Fitting

Fitting of the lever-type connector 100 to the mating connector 200 is started. The mating connector 200 has a configuration in which a large number of pin contacts 210 are arrayed and held in a housing 220 and the mating connector 200 is mounted on a substrate (not illustrated).

With the start of fitting, a fitting portion 221 of the housing 220 of the mating connector 200 is inserted into a gap between the seal stopper 80, which is attached to the front end side of the inner housing 30, and the outer housing 40 in the lever-type connector 100.

In this state, the convex portions 57a of the spring pieces 57 of the sliders 50U and 50L, which are respectively positioned in the upper and lower spaces between the inner housing 30 and the outer housing 40 of the lever-type connector 100, are pushed by inner surfaces of the upper plate portion 45 and the bottom plate portion 46 of the outer housing 40. That is, the sliders 50U and 50L are pushed by the spring pieces 57 to be maintained in a locked state in which the protrusions 34 of the inner housing 30 enter the concave portions 54, as illustrated in FIG. 8(a). Here, the illustration of socket contacts and wire harnesses is omitted, but in FIG. 6(1)(b), 93 denotes a grommet through which a wire of the wire harness is threaded.

Process (2): In the Middle of Fitting

As the fitting progresses, the end of the fitting portion 221 of the housing 220 in the mating connector 200 is abutted on the inclined surfaces 51 positioned on the front end in the fitting direction of the sliders 50U and 50L and the inclined surfaces 51 are pushed by the fitting portion 221. Accordingly, the sliders 50U and 50L are displaced in respective directions separating from the inner housing 30 against the spring force of the spring pieces 57. As a result, the protrusions 34 which have entered the concave portions 54 are disengaged from the concave portions 54 as illustrated in FIG. 8(b) and the locked state of the sliders 50U and 50L is thus released. The sliders 50U and 50L respectively ride up on upper and lower surfaces 221a and 221b of the fitting portion 221 of the housing 220 in the mating connector 200.

Process (3): In the Middle of Fitting

As the fitting further progresses, three driven bosses 222, which are formed in a protruding manner on each of the upper surface 221a and the lower surface 221b of the fitting portion 221 of the housing 220 in the mating connector 200, enter corresponding cam grooves 52 of the sliders 50U and 50L as illustrated in FIG. 9(b). The lever 60 becomes to be able to be operated in an arrow d direction around the supporting shaft 35.

Processes (3) to (4): In the Middle of Fitting

In response to the operation of the lever 60, the gears 65 which are rotating and the racks 56 mesh with each other and the sliders 50U and 50L accordingly performs a sliding operation in an arrow e direction as illustrated in FIG. 9(c). In response to the sliding operation of the sliders 50U and 50L, the lever-type connector 100 is drawn to the mating connector 200 and thus, the fitting further progresses.

Process (4): Fitting Completion

By rotating the lever 60 to a position illustrated in FIG. 7(4)(a), the fitting of the lever-type connector 100 to the mating connector 200 is completed. The driven bosses 222 of the mating connector 200 are positioned on inner ends of the cam grooves 52 of the sliders 50U and 50L as illustrated in FIG. 9(d).

Separation between the mating connector 200 and the lever-type connector 100, that is, disengagement of the lever-type connector 100 from the mating connector 200 is performed by operating the lever 60 to return the lever 60 from the position illustrated in FIG. 7(4)(a) to the position illustrated in FIG. 6(1)(a).

The configuration and operation of the lever-type connector according to the first embodiment of the present invention have been described above. According to the lever-type connector 100, the following actions and advantageous effects can be obtained.

1) In the state of separation from the mating connector 200, as the state in the above-described process (1), the sliders 50U and 50L are pushed by the spring pieces 57 to be in the locked state, in which the protrusions 34 of the inner housing 30 enter the concave portions 54, and the sliding operation thereof is thus blocked. Accordingly, the lever 60 which is coupled with the sliders 50U and 50L with the cam mechanism is also locked and the operation thereof is blocked.

Even if a force operating the lever 60 is applied to the lever 60 in this state, the direction of the force is orthogonal to the direction of the spring force of the spring pieces 57 pushing the sliders 50U and 50L. Therefore, the locked state of the sliders 50U and 50L cannot be released and accordingly, the lever 60 does not move.

Thus, according to the lever-type connector 100, an operation for checking the position of the lever 60 is not required in fitting with the mating connector 200.

2) In the state of completion of fitting with the mating connector 200, the convex portions 57a of the spring pieces 57 enter and are positioned in respective windows 47, which are provided to the outer housing 40 as illustrated in FIG. 7(4)(a). Accordingly, the spring pieces 57 are elastically restored and deformation thereof is relieved, being able to prevent settling.

3) The sliders 50U and 50L are configured in a manner such that the side surface of the projecting portion 53 provided along one long side is along the side surface of the projection portion 32 provided to the inner housing 30. Therefore, the sliders 50U and 50L are guided by the projection portion 32 and perform favorable slide movement.

4) In the state of completion of fitting with the mating connector 200, the protrusion 66 provided to the lever 60 is caught on a projection portion 71 which is formed on the harness cover 70 in a projecting manner. Therefore, the lever 60 does not easily move and the position thereof is stably maintained.

5) In the state of separation from the mating connector 200, the lever 60 is locked as described above and the operation in the arrow d direction is blocked. Meanwhile, stepped portions 72 that protrude mutually outward are formed on the harness cover 70 as illustrated in FIG. 3. Accordingly, even if a force in an opposite direction to the arrow d direction, for example, is applied to the lever 60 in the state of separation from the mating connector 200, the stepped portions 72 restrict movement of the lever 60.

### Second Embodiment

A configuration of a lever-type connector according to a second embodiment of the present invention will now be described.

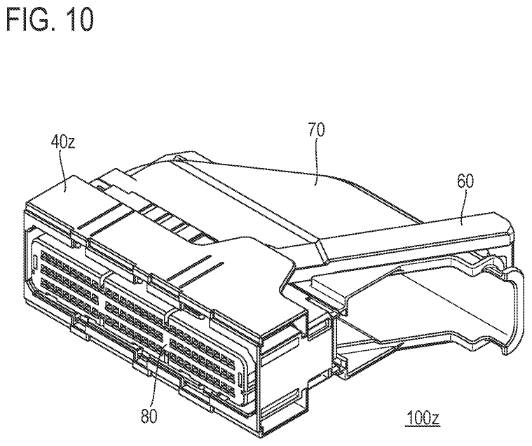

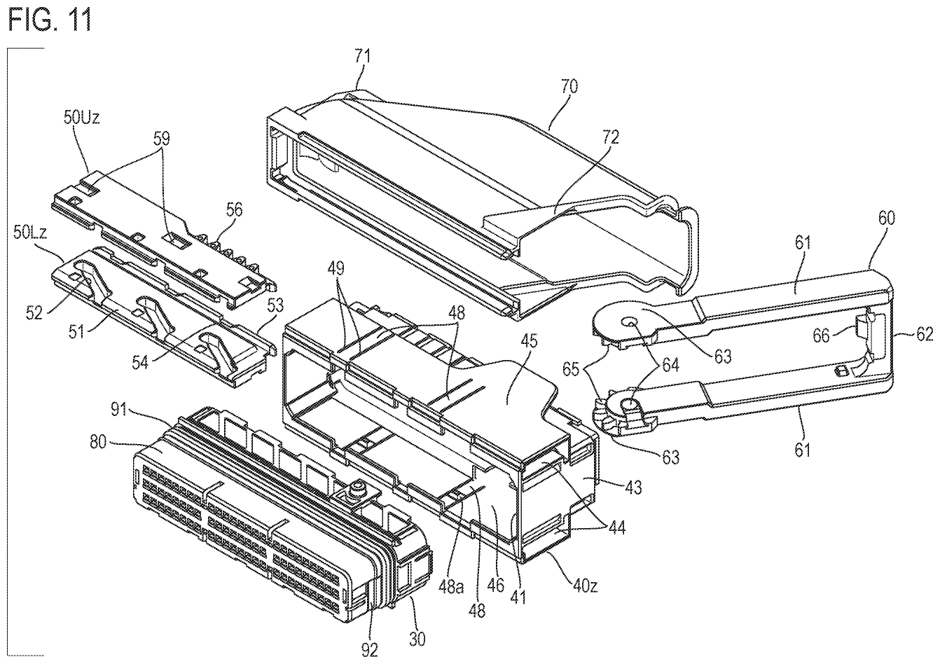

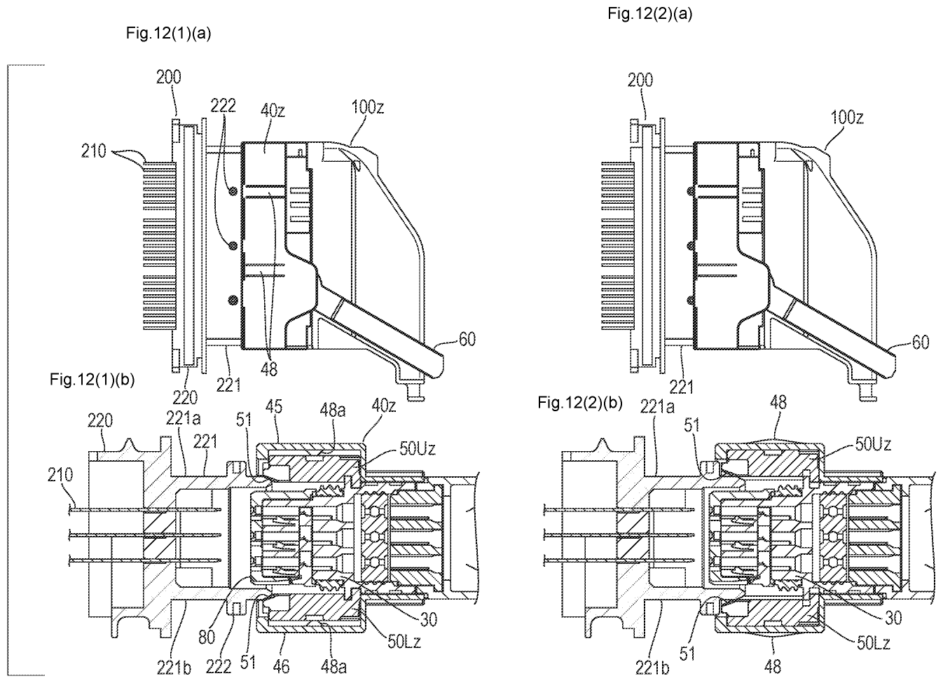

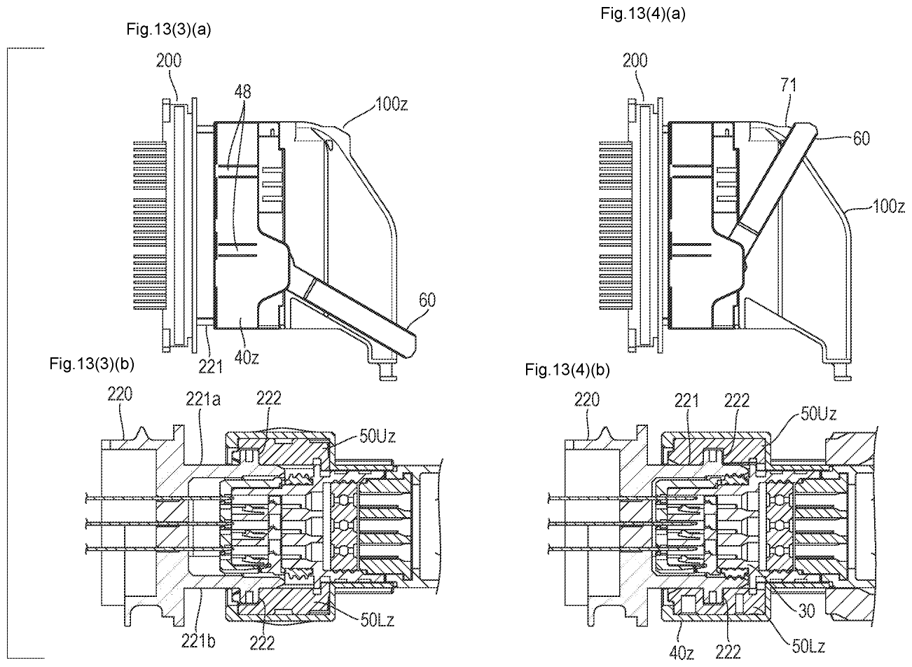

FIG. 10 illustrates an outer appearance of a lever-type connector 100z according to the second embodiment, and FIG. 11 illustrates the lever-type connector 100z as an exploded view with some portions removed. FIGS. 12(1) and 12(2) and FIGS. 13(3) and 13(4) illustrate processes (1) to (4) of fitting between the lever-type connector 100z and the mating connector 200 similarly to the processes (1) to (4) in the first embodiment. In FIGS. 10 to 13, portions corresponding to those of the first embodiment will be provided with the same reference characters and detailed description thereof will be omitted.

In this example, spring pieces, which are provided for pushing sliders so as to produce a locked state of the sliders, are integrally formed not on the sliders but on an outer housing 40z. Two spring pieces 48 having a double-supported beam shape are formed on each of the upper plate portion 45 and the bottom plate portion 46 of the outer housing 40z. There are long and thin slits 49 on both sides in the width direction of each spring piece 48, that is, the spring piece 48 is configured between the slits 49 which are provided in a pair. A convex portion 48a is formed in a protruding manner at the center in the longitudinal direction of an inner surface, facing the accommodation space 41, of each spring piece 48.

Meanwhile, recesses 59 are formed on the upper surface 50b of a slider 50Uz, and recesses 59 are also formed on a slider 50Lz in a similar manner.

In this example, the sliders 50Uz and 50Lz are configured in a manner such that the sliders 50Uz and 50Lz are pushed by the convex portions 48a of the spring pieces 48, which are integrally formed on the outer housing 40z, to be in the locked state as is the case with the first embodiment. The operation in the processes (1) to (4) of fitting with the mating connector 200 is the same as that of the first embodiment other than that springs for pushing the sliders 50Uz and 50Lz against the inner housing 30 are the spring pieces 48 integrally formed on the outer housing 40z.

In the state of completion of fitting with the mating connector 200, the convex portions 48a of the spring pieces 48 enter and are positioned in respective recesses 59, which are provided to the sliders 50Uz and 50Lz. Accordingly, the spring pieces 48 are elastically restored and deformation thereof is relieved, and therefore, settling is prevented as is the case with the first embodiment.

### Third Embodiment

The spring pieces 57 are integrally formed on the sliders 50U and 50L in the first embodiment and the spring pieces 48 are integrally formed on the outer housing 40z in the second embodiment so as to push the sliders against the inner housing with the spring force of these spring pieces and to lock the sliders. However, a configuration in which such a spring piece is not intentionally provided can also be employed.

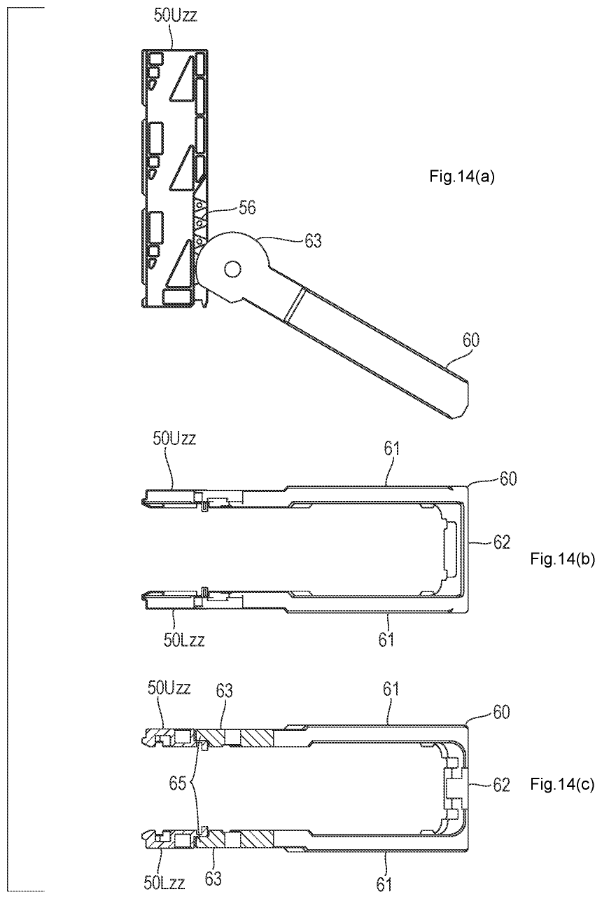

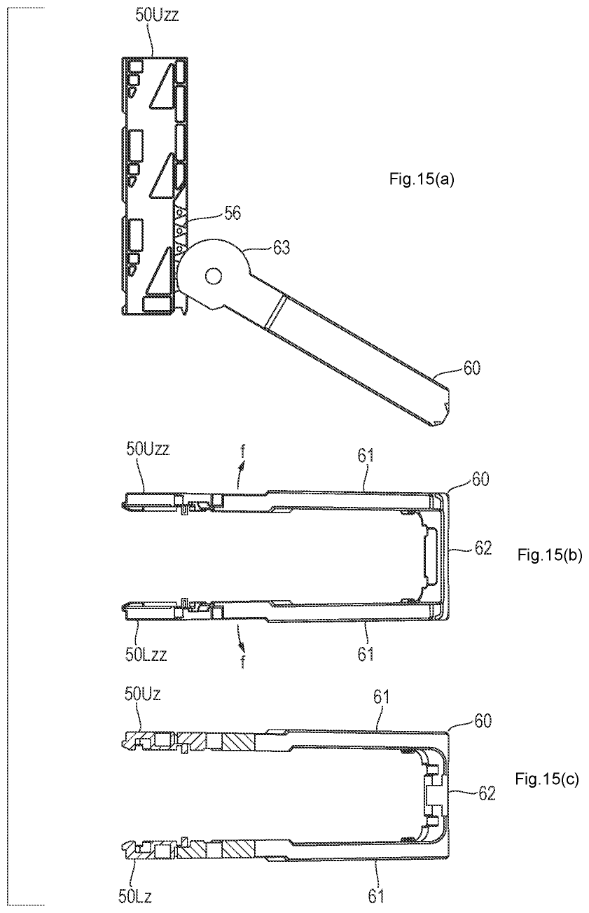

A third embodiment employs such a configuration including no spring pieces, and the configuration and operation thereof will be described with reference to FIGS. 14 and 15.

The lever 60 of a lever-type connector has a U shape formed by two arm portions 61 and the coupling portion 62 that couples the arm portions 61 to each other as described above, as illustrated in FIG. 14. In this example, these two arm portions 61 are configured to function as springs for pushing sliders 50Uzz and 50Lzz to produce the locked state of the sliders 50Uzz and 50Lzz.

FIG. 14 illustrates states of the lever 60 and the sliders 50Uzz and 50Lzz in the state of separation from a mating connector, and FIG. 15 illustrates the states of the lever 60 and the sliders 50Uzz and 50Lzz when fitting to the mating connector is performed and the locked state of the sliders 50Uzz and 50Lzz is released.

The sliders 50Uzz and 50Lzz are pressed in directions, in which the sliders 50Uzz and 50Lzz mutually approach, by the disc portion 63 and the gear 65, which are provided to each one end (tip) of two arm portions 61, as illustrated in FIG. 14 and thus, the sliders 50Uzz and 50Lzz can be locked. On the other hand, in the fitting state with the mating connector, the sliders 50Uzz and 50Lzz are displaced in directions separating from each other against the spring force of two arm portions 61, as illustrated in FIG. 15. In this state, the two arm portions 61 move opening in respective directions of arrows f.

Thus, the lever 60 may be made function as a spring for pushing sliders.

The embodiments of the lever-type connector according to the present invention have been described above. However, in terms of the protrusion for locking the slider and the concave portion which the protrusion enters, the protrusion may be provided to a slider and the concave portion may be provided to an inner housing in an opposite way to the embodiments.

### DESCRIPTION OF REFERENCE NUMERALS

10: lever-type connector
11: lever
11a: protrusion for slider movement
12: outer housing
12a: slider accommodating groove
13: front cover
14: slider
14a to 14c: cam groove
14d: concave portion
15: wire cover
15a: restricting protrusion
15b: locking member
20: counterpart connector
21: fitting portion
21a to 21c: cam pin
30: inner housing
30a: upper surface
30b: lower surface
31: insertion hole
32: projection portion
33: groove
34: protrusion
35: supporting shaft
40, 40z: outer housing
41: accommodation space
42, 43: side surface
44: opening
45: upper plate portion
46: bottom plate portion
47: window
48: spring piece
48a: convex portion
49: slit
50U, 50Uz, 50Uzz: slider
50L, 50Lz, 50Lzz: slider
50a: lower surface
50b: upper surface
51: inclined surface
52: cam groove
53: projecting portion
54: concave portion
55: groove
56: rack
57: spring piece
57a: convex portion
58: window
59: recess
60: lever
61: arm portion
62: coupling portion
63: disc portion
64: shaft hole
65: gear
66: protrusion
70: harness cover
71: projection portion
72: stepped portion
80: seal stopper
91: seal ring
92: retainer
93: grommet
100, 100z: lever-type connector
200: mating connector
210: pin contact
220: housing
221: fitting portion
221a: upper surface
221b: lower surface
222: driven boss

1-6. (canceled)

7. A lever-type connector comprising:
a slider on which a cam groove, which a driven boss provided to a mating connector is to enter, is formed; and
a lever that makes the slider perform a sliding operation, wherein
fitting and separation between the lever-type connector and the mating connector are performed through an operation of the lever,
the slider is positioned in a space between an inner housing, the inner housing holding a contact, and an outer housing accommodating the inner housing,
the slider has an inclined surface on a front end in a fitting direction with the mating connector,
a protrusion is formed on one of opposed surfaces of the slider and the inner housing and a concave portion is formed on the other,
in a separation state from the mating connector, the slider is pushed by a spring to be in a locked state, in which the protrusion enters the concave portion, and accordingly, the sliding operation is blocked and the operation of the lever is blocked, and
when fitting with the mating connector is started, the inclined surface of the slider is pushed by a housing of the mating connector, and accordingly, the slider is displaced in a direction separating from the inner housing against a spring force of the spring, and the locked state is released.

8. The lever-type connector according to claim 7, wherein
the spring is a spring piece that is integrally formed on the slider and has a convex portion, the convex portion being pushed by an inner surface of the outer housing, and
a window, which the convex portion enters to elastically restore the spring piece in a state of completion of the fitting with the mating connector, is formed on the outer housing.

9. The lever-type connector according to claim 7, wherein
the spring is a spring piece that is integrally formed on the outer housing and has a convex portion, the convex portion pushing the slider, and
a recess, which the convex portion enters to elastically restore the spring piece in a state of completion of the fitting with the mating connector, is formed on the slider.

10. The lever-type connector according to claim 7, wherein the slider is positioned in each of upper and lower spaces between the inner housing and the outer housing.

11. The lever-type connector according to claim 8, wherein the slider is positioned in each of upper and lower spaces between the inner housing and the outer housing.

12. The lever-type connector according to claim 9, wherein the slider is positioned in each of upper and lower spaces between the inner housing and the outer housing.

13. The lever-type connector according to claim 7, wherein
the slider is positioned in each of upper and lower spaces between the inner housing and the outer housing,
the lever has a U shape formed by two arm portions, whose one ends are positioned respectively on the two sliders, and a coupling portion that couples the other ends of the two arm portions to each other, and
each of the two arm portions functions as the spring.

14. The lever-type connector according to claim 7, wherein the sliding operation of the slider, to which a rack is formed, is performed by rotating a gear through the operation of the lever, the gear being formed on the lever to be engaged with the rack.

15. The lever-type connector according to claim 8, wherein the sliding operation of the slider, to which a rack is formed, is performed by rotating a gear through the operation of the lever, the gear being formed on the lever to be engaged with the rack.

16. The lever-type connector according to claim 9, wherein the sliding operation of the slider, to which a rack is formed, is performed by rotating a gear through the operation of the lever, the gear being formed on the lever to be engaged with the rack.

17. The lever-type connector according to claim 10, wherein the sliding operation of the slider, to which a rack is formed, is performed by rotating a gear through the operation of the lever, the gear being formed on the lever to be engaged with the rack.

18. The lever-type connector according to claim 11, wherein the sliding operation of the slider, to which a rack is formed, is performed by rotating a gear through the operation of the lever, the gear being formed on the lever to be engaged with the rack.

19. The lever-type connector according to claim 12, wherein the sliding operation of the slider, to which a rack is formed, is performed by rotating a gear through the operation of the lever, the gear being formed on the lever to be engaged with the rack.

20. The lever-type connector according to claim 13, wherein the sliding operation of the slider, to which a rack is formed, is performed by rotating a gear through the operation of the lever, the gear being formed on the lever to be engaged with the rack.
